(19) United States
(12) Patent Application Publication
(10) Pub. No.: US 2016/0085312 A1
(43) Pub. Date: Mar. 24, 2016

(54) GESTURE RECOGNITION SYSTEM

(71) Applicants: NCKU Research and Development Foundation, Tainan City (TW); Himax Technologies Limited, Tainan City (TW)

(72) Inventors: MING-DER SHIEH, Tainan City (TW); Jia-Ming Gan, Tainan City (TW); DER-WEI YANG, Tainan City (TW); TZUNG-REN WANG, Tainan City (TW)

(21) Appl. No.: 14/495,808

(22) Filed: Sep. 24, 2014

(51) Int. Cl. G06F 3/01; G06K 9/46; H04N 19/553; G06T 7/20; H04N 19/513; G06K 9/00; H04N 13/02

(52) U.S. Cl. CPC G06F 3/017; G06K 9/00342; G06K 9/4652; H04N 13/0271; G06T 7/2073; H04N 19/513; H04N 19/553; G06T 2200/04; G06T 2207/10004; G06T 2207/10028; G06T 2207/30196; G06T 2207/30241; G06T 2207/10024

(57) ABSTRACT

A gesture recognition system includes a candidate node detection unit coupled to receive an input image in order to generate a candidate node; a posture recognition unit configured to recognize a posture according to the candidate node; a multiple hands tracking unit configured to track multiple hands by pairing between successive input images; and a gesture recognition unit configured to obtain motion accumulation amount according to tracking paths from the multiple hands tracking unit, thereby recognizing a gesture.

### BACKGROUND OF THE INVENTION

1. Field of the Invention

The present invention generally relates to a gesture recognition system, and more particularly to a gesture recognition system capable of being performed in a complex scene.

2. Description of Related Art

Natural user interface, or NUI, is a user interface that is invisible and requires no artificial control devices such as a keyboard and mouse. Instead, the interaction between humans and machines is achieved, for example, through hand postures or gestures. Kinect by Microsoft is one example of a vision-based gesture recognition system that uses postures and/or gestures to facilitate interaction between a user and a computer.

Conventional vision-based gesture recognition systems are liable to make erroneous judgments on object recognition owing to surrounding lighting and background objects. After extracting features from a recognized object (a hand in this case), classification is performed via a training set, from which a gesture is recognized. Conventional classification methods suffer either large training data or erroneous judgments due to unclear feature.

For the foregoing reasons, a need has thus arisen to propose a novel gesture recognition system that is capable of more accurately and fast recognizing postures and/or gestures.

### SUMMARY OF THE INVENTION

In view of the foregoing, it is an object of the embodiment of the present invention to provide a robust gesture recognition system that may perform properly in a complex scene and reduce complexity of posture classification.

According to one embodiment, a gesture recognition system includes a candidate node detection unit, a posture recognition unit, a multiple hands tracking unit and a gesture recognition unit. The candidate node detection unit receives an input image in order to generate a candidate node. The posture recognition unit recognizes a posture according to the candidate node. The multiple hands tracking unit tracks multiple hands by pairing between successive input images. The gesture recognition unit obtains motion accumulation amount according to tracking paths from the multiple hands tracking unit, thereby recognizing a gesture.

### BRIEF DESCRIPTION OF THE DRAWINGS

FIG. 1 shows a block diagram illustrated of a gesture recognition system according to one embodiment of the present invention;

FIG. 2 shows a flow diagram illustrating steps performed by the candidate node detection unit of FIG. 1;

FIG. 3 shows a flow diagram illustrating steps performed by the posture recognition unit of FIG. 1;

FIG. 4 shows an exemplary distance curve;

FIG. 5 shows exemplary classification of the postures according to the amount of recognized unfolding fingers;

FIG. 6 exemplifies multiple hands being tracked by pairing between successive frames;

FIG. 7A shows a natural user interface for drawing on a captured image with one hand; and

FIG. 7B shows an exemplary gesture using the postures of FIG. 7A.

### DETAILED DESCRIPTION OF THE INVENTION

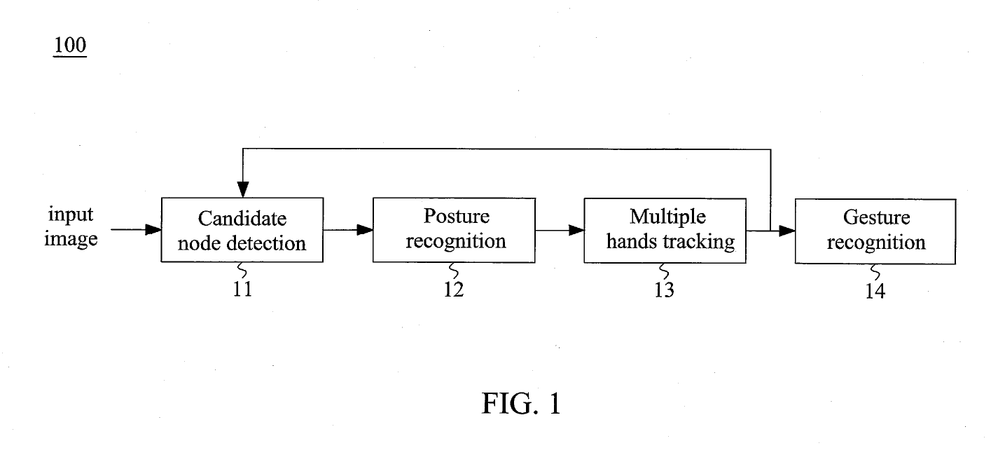

FIG. 1 shows a block diagram illustrated of a gesture recognition system 100 according to one embodiment of the present invention. In the embodiment, the gesture recognition system 100 primarily includes a candidate node detection unit 11, a posture recognition unit 12, a multiple hands tracking unit 13 and a gesture recognition unit 14, details of which will be described in the following. The gesture recognition system 100 may be performed by a processor such as a digital image processor.

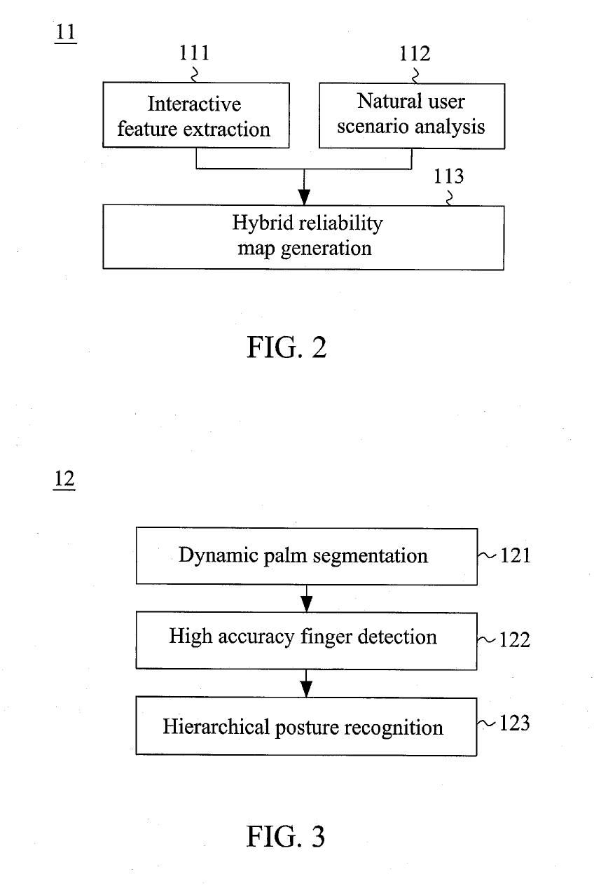

FIG. 2 shows a flow diagram illustrating steps performed by the candidate node detection unit 11 of FIG. 1. In step 111 (i.e., interactive feature extraction), features are extracted according to color, depth and motion, thereby generating a color reliability map, a depth reliability map and a motion reliability map.

Specifically speaking, the color reliability map is generated according to skin color of a captured input image. In the color reliability map, a higher value is assigned to a pixel that is more like the skin color.

The depth reliability map is generated according to hand depth of the input image. In the depth reliability map, a higher value is assigned to a pixel that is within a hand depth range. In one exemplary embodiment, a face is first recognized by a face recognition technique, and the hand depth range is then determined with respect to depth of the recognized face.

The motion reliability map is generated according to motion of a sequence of input images. In the motion reliability map, a higher value is assigned to a pixel that has more motion, for example, measured by sum of absolute differences (SAD) between two input images.

In step 112 (i.e., natural user scenario analysis), weightings of the extracted color, depth and motion are determined with respect to operation status, such as initial statement, motion or whether hand is close to face. Table 1 shows some exemplary weightings:

TABLE 1

| Operation status | | | | | |
|---|---|---|---|---|---|
| Initial | | Hand close | Weight | | |
| statement | Motion | to face | Color | Depth | Motion |
| No | Strong | No | 0.286 | 0.286 | 0.429 |
| No | Strong | Yes | 0.25 | 0.375 | 0.375 |
| No | Low | No | 0.5 | 0.5 | 0 |
| No | Low | Yes | 0.4 | 0.6 | 0 |
| Yes | Strong | Don't | 0 | 0.4 | 0.6 |
| | | care | | | |
| Yes | Low | Don't | 0 | 1 | 0 |
| | | care | | | |

Finally, in step 113, the color reliability map, the depth reliability map and the motion reliability map are combined with the respective weightings given in step 112, thereby generating a hybrid reliability map, which provides a detected candidate node.

FIG. 3 shows a flow diagram illustrating steps performed by the posture recognition unit 12 of FIG. 1. In step 121 (i.e., dynamic palm segmentation), the detected hand (from the candidate node detection unit 11) is segmented into a palm (which is used later) and an arm (which is discarded).

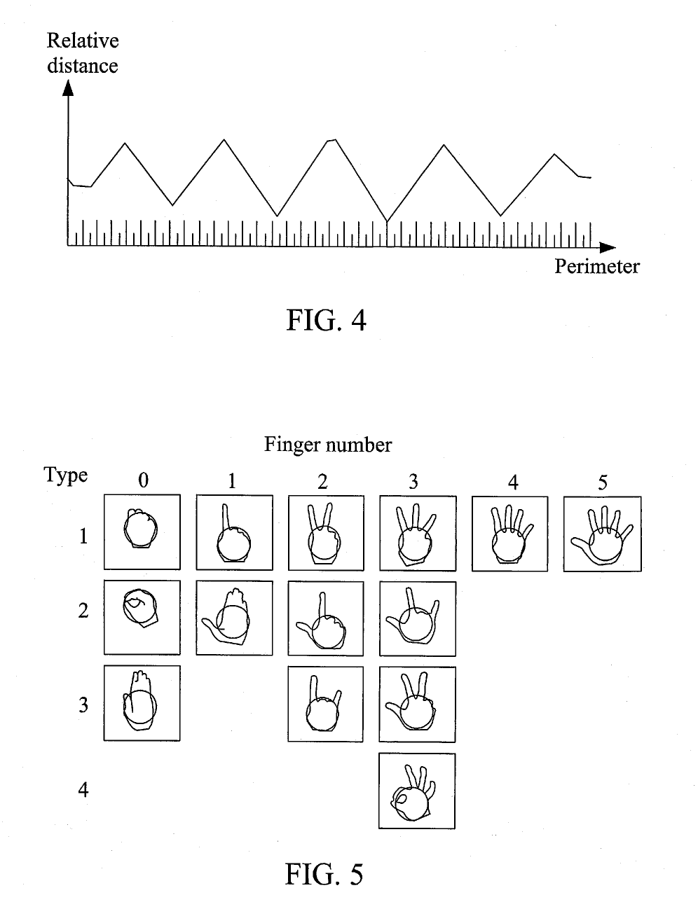

In step 122 (i.e., high accuracy finger recognition), a distance curve is generated by recording relative distances between the center of the segmented palm and perimeter (or boundary) of the segmented palm. FIG. 4 shows an exemplary distance curve, which has five peaks, indicating that five unfolding fingers have been recognized.

In step 123 (i.e., hierarchical posture recognition), a variety of recognized postures are classified for facilitating the following process. FIG. 5 shows exemplary classification of the postures according to the amount of recognized unfolding fingers. When recognizing a posture in a hierarchical manner, the amount of unfolding fingers is first determined. Jointed fingers may be detected by computing the width of the recognized fingers. Next, hole and its width indicating folded finger(s) between unfolding fingers are then determined.

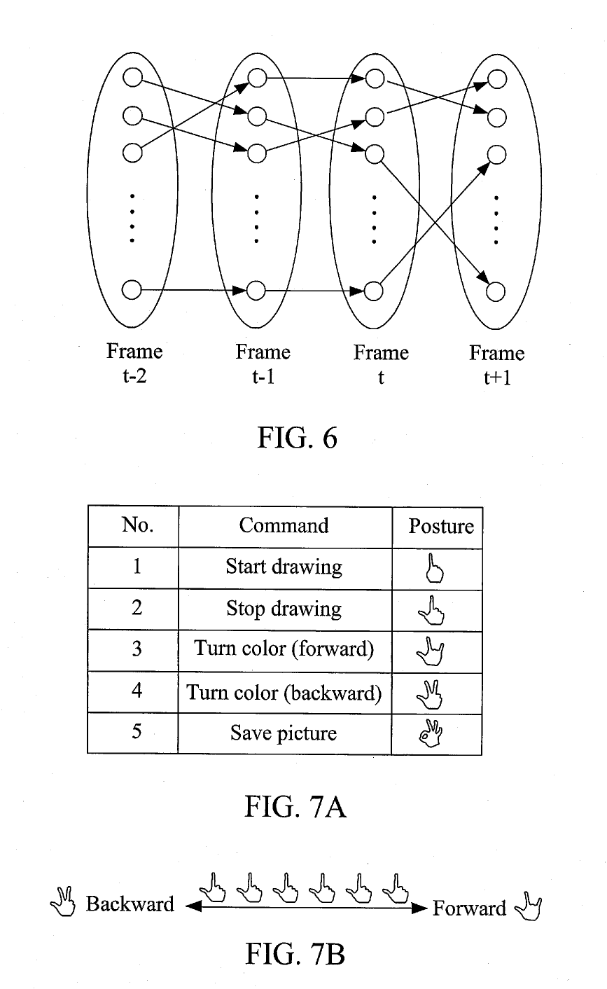

In the multiple hands tracking unit 13 of FIG. 1, multiple hands are tracked by pairing (or matching) between successive frames as exemplified in FIG. 6, in which tracking path exists between a pair of matched track hands. In a case of unmatched track hand due to object leave, the corresponding tracking path may be deleted. In another case of unmatched track hand due to occlusion, an expected track hand may be generated by extrapolation technique. In a further case of unmatched track hand due to object arrival, a new posture need be recognized and then a new path may then be tracked. In case of unmatched track hands, feedback may be fed back to the candidate node detection unit 11 (as shown in FIG. 1) to discard the associated candidate node.

In the gesture recognition unit 14 of FIG. 1, the tracking paths are monitored to obtain their motion accumulation amount along axes in a three-dimensional space, thereby recognizing a gesture. The recognized gesture may then be fed to a natural user interface for performing a pre-defined task.

FIG. 7A shows a natural user interface for drawing on a captured image with one hand. As exemplified in FIG. 7B, after the posture No. 1 (not shown in FIG. 7B), a user may draw a line using a series of the posture No. 2, constructing a gesture, during which the user may change color using the posture No. 3 or No. 4.

Although specific embodiments have been illustrated and described, it will be appreciated by those skilled in the art that various modifications may be made without departing from the scope of the present invention, which is intended to be limited solely by the appended claims.

What is claimed is:

1. A gesture recognition system, comprising:
a candidate node detection unit coupled to receive an input image in order to generate a candidate node;
a posture recognition unit configured to recognize a posture according to the candidate node;
a multiple hands tracking unit configured to track multiple hands by pairing between successive input images; and
a gesture recognition unit configured to obtain motion accumulation amount according to tracking paths from the multiple hands tracking unit, thereby recognizing a gesture.

2. The system of claim 1, wherein the candidate node detection unit performs the following steps:
extracting features according to color, depth and motion, thereby generating a color reliability map, a depth reliability map and a motion reliability map, respectively;
determining weightings of the color, depth and motion with respect to operation status; and
combining the color reliability map, the depth reliability map and the motion reliability map with the respective weightings, thereby generating a hybrid reliability map, which provides the candidate node.

3. The system of claim 2, wherein the color reliability map is generated according to skin color of the input image.

4. The system of claim 2, wherein the depth reliability map is generated according to hand depth of the input image.

5. The system of claim 4, wherein a higher value is assigned to a pixel that is within a hand depth range in the depth reliability map.

6. The system of claim 2, wherein the motion reliability map is generated according to motion of a sequence of input images.

7. The system of claim 6, wherein the motion in the motion reliability map is measured by sum of absolute differences (SAD) between two input images.

8. The system of claim 2, wherein the operation status comprises initial statement, motion, whether hand is close to face or combination thereof.

9. The system of claim 1, wherein the posture recognition unit performs the following steps:
segmenting a palm from a hand associated with the candidate node;
generating a distance curve by recording relative distances between a center of the segmented palm and perimeter of the segmented palm, thereby recognizing a posture; and
classifying a plurality of the recognized postures.

10. The system of claim 9, wherein the plurality of the recognized postures are classified according to an amount of recognized unfolding fingers.

11. The system of claim 1, in the multiple hands tracking unit, a tracking path is deleted in case of unmatched track hand due to object leave.

12. The system of claim 1, in the multiple hands tracking unit, an expected track hand is generated by extrapolation technique in case of unmatched track hand due to occlusion.

13. The system of claim 1, in the multiple hands tracking unit, a new tracking path is generated in case of unmatched track hand due to object arrival.

14. The system of claim 1, wherein feedback is fed from the multiple hands tracking unit to the candidate node detection unit in case of unmatched track hands.

15. The system of claim 1, wherein the recognized gesture is fed to a natural user interface for performing a pre-defined task.

16. The system of claim 15, wherein a user draw a line using the recognized gesture according to the natural user interface.
